(19) United States
(12) Patent Application Publication
(10) Pub. No.: US 2008/0113056 A1
(43) Pub. Date: May 15, 2008

(54) Injection Molding Machine With a Pair of Molding Inserts that Can Be Removed From a Holding Device

(75) Inventor: Reinhard Schnurr, Auerbach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ZAHORANSKY GMBH FORMEN-UND WERKZEUGBAU, Steinberg (DE)

(21) Appl. No.: 11/722,551

(22) PCT Filed: Jan. 19, 2006
(86) PCT No.: PCT/EP06/00467

§ 371 Date: Jun. 22, 2007

(30) Foreign Application Priority Data
Jan. 22, 2005 (DE) 102005003074.2

(51) Int. Cl. B29C 45/76; B29C 45/26; B29C 45/04

(52) U.S. Cl. 425/162; 425/192 R

(57) ABSTRACT

An injection molding machine (1) for injection molding of injection molded parts (32) preferably having a foamed core and an enclosure made of a shell material is provided. The machine includes an injection station (2) with an injection molding tool that can be placed inside a holding device (6). The injection molding tool has a pair of molding inserts (7), including a nozzle-side mold half (7a) and a closing-side mold half (7b). A number of pairs of molding inserts (7) are provided that have locking devices for holding the pairs of molding inserts (7) together when the holding device (6) is open. Thus, they can be removed from the holding device (6) while locked. In addition, at least one storage and cooling station (3) and at least one molding release station (4) are provided. A conveying device (5) for conveying pairs of molding inserts (7) between the stations (2 to 4) is provided with the at least one injection station (2), the at least one storage and cooling station (3), and the at least one molding release station (4).

### BACKGROUND

The invention relates to an injection molding machine for molding injection molded parts with a core and an enclosure comprising a shell material, having an injection station and an injection molding tool that can be inserted there at a holding device, which has pair of molding inserts with their molding inserts forming a nozzle-side molding half and a closing-side molding half.

Such known injection molding machines allow a cost-effective production of voluminous injection molded parts, such as for example shoe soles, household brushes, and the like, among other things, because cheap material can be used for the foamed core. Due to the foamed core the processing can occur with relatively low pressure. This results in the possibility of using molds made from light metal, which facilitates processing and is more cost-effective.

However, for cooling the injection molded parts a relatively long cooling period is required, so that accordingly the cycle time is extended and, for example, lasts 120 seconds or more. The constant interior pressure inside the injection molded part, maintained by the foaming agent in the foamed core, also contributes to this long cycle time.

It has also been known to release the injection molding parts after a partial cooling time and to transport them into a water bath. However, here in addition to the problem that the injection molded parts may float in the water bath and thus are subject to an non-homogeneous cooling, another problem arises, that the active foaming agent inside the injection molded core frequently causing bulging, which leads to rejections.

In order to better use the long cycle period it is known to provide a carousel arrangement with several, for example, eight closing units with molds held therein. By rotating the carousel arrangement the molds held together by the respective closing units can successively be allocated to an injection unit arranged at the periphery, in order to perform a respective injection molding process Then the closed molds can be further conveyed in the respective closing unit until sufficient cooling of the injection molded parts is achieved. The number of circulating molds per closing unit depends on the cooling period and the time necessary for the respective injection molding process. Overall, both due to the necessary number of molds with closing units as well as by the arrangement of the carousel for rotating the mold/closing units high expenses arise.

### SUMMARY

The object of the present invention is to provide an injection molding machine of the type mentioned at the outset which requires little machine expense and allows a flexible retrofitting for different injection molded parts with little expense.

In order to attain this object it is suggested that several pairs of molding inserts are provided, having closing means for holding the pairs of molding inserts together in an opened holding device and which can be removed from the holding device in the closed position such that at least one storage and cooling station and at least one molding release station is provided and that a conveying device for conveying the pair of molding inserts is provided between the stations with at least one injection station, at least one storage and cooling station, and at least one molding release station.

Using this injection molding machine the expenses are considerably reduced, because only a single closing unit is necessary, which primarily has to apply the necessary counter pressure only for holding the respective pair of molding inserts against the pressure of the injection nozzle (s), because the mold halves are held together by the locking means. In particular, the injection pressure is relatively low in the cores of the injection molded parts foamed by foaming agents and can amount to 200 bar, for example. The molds may therefore comprise light metal, in particular aluminum, perhaps also plastic, allowing a simple, cost-effective processing.

After the injection molding process the pair of molding inserts can immediately be removed from the area of the injection unit together with the injection molded part or parts and be deposited at a storage and cooling station. Simultaneously an empty pair of molding inserts is inserted into the injection station. The injection cycle period is therefore reduced considerably.

After cooling the injection molded parts located in the closed pair of molding inserts the injection unit is conveyed to the molding release station, opened, and the injection molded part is expelled. The empty injection unit is closed and locked and is available again for the next injection process.

These processes repeat in the other pairs of molding inserts in a circuit until the first pair of molding inserts is again available after molding release. An appropriate number of pairs of molding inserts are necessary, here.

Means for unlocking and locking the locking element and for opening and closing the pairs of molding inserts as well as means for expelling the injection sprue are available at the molding release station.

Advantageously, there is the possibility optionally to produce different injection molded parts, and, adjusted to different production periods and different numbers of items requested to provide a mixed production, which allows to optimize the performance of the injection molding machine. For example, during the cooling period of voluminous injection molded parts the injection molding of one or more smaller injection molded parts with shorter cycle periods can be intermittently performed. Here, this infiltration of smaller injection molded parts and/or molded parts with a lesser volume can occur flexibly with different injection molded parts, with their individual or overall cycle periods being equivalent to the individual cycle period of the voluminous injection molded part or several of these subsequently injection molded parts.

The provided pairs of molding inserts can therefore be embodied for different injection molded parts and are optionally available for a flexible production.

The conveyer device is connected in particular to a control, which is provided with a memory for the storage positions of the molding inserts as well as the injection parameters and cooling parameters allocated thereto, so that during the optional grasping of molding inserts simultaneously the allocated features for the injection process are also provided.

The holding device for the injection molding tool at the injection station is beneficially formed by a commercial closing unit. A relatively small, cost-effective closing unit is sufficient, because during the injection process essentially only the pressure for countering the pressure of the injection nozzle must be provided.

The closing unit, provided with a fixed nozzle-side machine plate and a movable closing-side machine plate, between which a pair of molding inserts can be inserted, has a carrier holder for the pair of molding inserts at the movable plate. When opening the closing unit, the pair of molding inserts is carried therewith and thus removed from the nozzle-side plate so that with the opening of the closing unit immediately space becomes available for inserting and clamping a new pair of molding inserts. This contributes to a rapid exchange of the pairs of molding inserts in the injection station.

Preferably the conveying device is formed by a robotic handling device, in particular having a bending-arm robot, for conveying the pair of molding inserts between the individual stations. The bending-arm robot can quickly and precisely perform all arising positioning tasks for conveying the pair of molding inserts between the individual stations.

Additional embodiments of the invention are listed in the other sub claims. In the following the essential parts of the invention are explained in greater detail using the drawings.

### BRIEF DESCRIPTION OF THE DRAWINGS

Shown schematically are:

FIG. 1 a top view of an injection molding machine according to the invention with an injection station, a molding release station, as well as four storage and cooling stations and a centrally arranged conveying device,

FIG. 2 and FIG. 3 top views of the injection molding device shown in FIG. 1 in different operational positions,

FIG. 4 to FIG. 6 partially in a cross-section, side views of the injection molding machine shown in FIGS. 1 to 3 in different operational positions,

FIG. 7 an exterior side view of a nozzle-side mold half with distribution channels and locking means,

FIG. 8 a partially cross-sectional, partial side view of an injection unit with several injection nozzles, and

FIG. 9 to FIG. 11 detailed views of a pair of molding inserts in the area of the locking means.

### DETAILED DESCRIPTION OF THE PREFERRED EMBODIMENTS

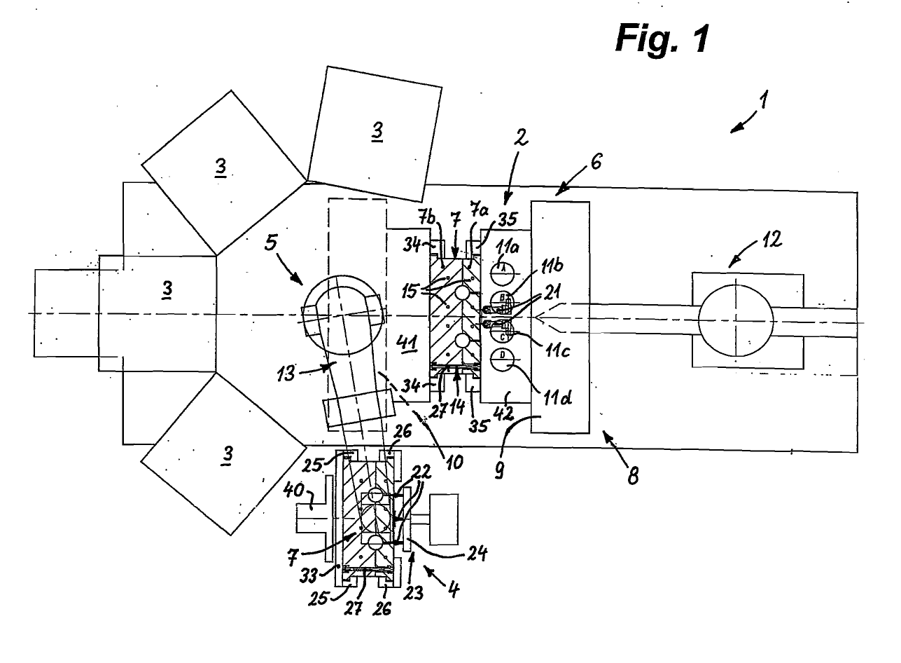

An injection molding machine 1 shown in FIGS. 1 through 6 serves to inject injection molding parts 32 with a foamed core. In the exemplary embodiment it is provided with an injection station 2, four storage and cooling stations 3, as well as a molding release station 4. These stations 2 through 4 are arranged around a conveying device 5.

A holding device 6 is provided at the injection station for one pair of molding inserts 7 each, comprising a nozzle-side mold half 7a and a closing-side mold half 7b. The pair of molding inserts 7 essentially form an injection molding tool. The holding device 6 therefore is formed in the exemplary embodiment by a closing unit 8, provided with a fixed nozzle-side machine plate 9 and a movable closing-side machine plate 10. On the machine plate 9 there is a hot-channel distribution plate 42 and on the machine plate 10 a carrier plate 41 for a carrier holder 34.

A pair of molding inserts 7 can be inserted between these plates 41, 42 for an injection process. In the exemplary embodiment a total of five injection aggregates are provided, with four injection aggregates 11a through 11d serving to inject an enclosure of injection molded parts, while an injection aggregate 12 being provided for injecting core material for these injection molded parts. This way, injection molded parts with foamed cores can be produced in the so-called co-injection method.

The conveying device 5, arranged centrally in reference to the stations 2 through 4 preferably arranged in a circular fashion around it, is formed in the exemplary embodiment by a robotic-handling device with a bending-arm robot 13, which is embodied with six axes and which can convey the pairs of molding inserts 7, several of which are circulated, between the stations 2 through 4. The bending-arm robot 13 has a grasping arm, which can engage the pairs of molding inserts 7 at the appropriately adjusted locations.

The pairs of molding inserts 7 are provided with locking means 14, by which they and/or their two mold halves 7a, 7b can be held together even after the removal from the opened closing unit 8 and during the conveyance to the storage and cooling stations and/or to the molding release station 4. The pairs of molding inserts 7 can also be removed from the closing unit 8 immediately after the end of the injection molding process, so that it is then immediately available for another injection molding process with another pair of molding inserts 7. The cycle period for the injection molding process can therefore be kept extremely short. Through the use of the locking means 14 holding the mold halves 7a, 7b together, also effective during the injection molding process, a relatively small closing unit can be used as the closing unit 8, which is capable pressing the pair of molding inserts 7 with sufficient pressure against the fixed machine plate 9 of the closing unit.

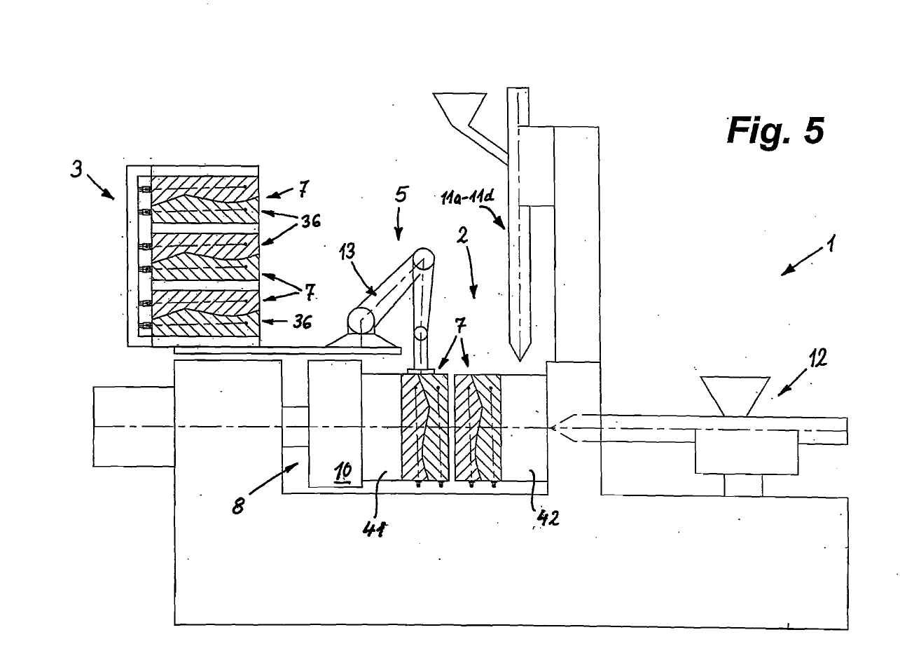

After the injection process, which may take for example 15 seconds depending on the injection molded part, the closing unit 8 is opened, with the pair of molding inserts 7 being carried with the movable machine plate 10 of the closing unit 8 and/or the carrier plate 41 located thereupon, as indicated in FIG. 5. For this purpose, the closing-side mold half 7b engaging carrier plate 41 is provided with a carrier holder 34. A holder 35 is also provided at the hot-channel distribution plate 42 held by the nozzle-side machine plate 9 of the closing unit 8. Both holding devices are adjustable independent from each other into the holding and loosening position, respectively. When opening the closing unit 8, the carrier holder 34 can remain closed, here, (while) and the holder 35 is opened and the pair of molding inserts 7 is released.

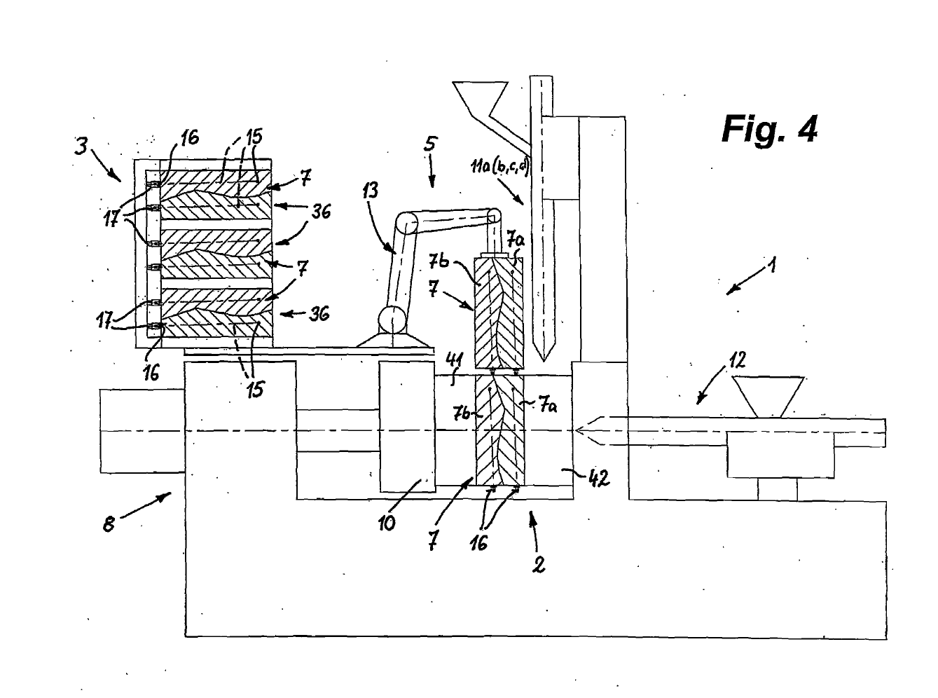

In FIG. 4 it is discernible that even when the closing unit 8 is closed an empty pair of molding inserts 7 can be positioned in a readiness position by the bending-arm robot 13 above the pair of molding inserts 7 located in the closing unit 8. After opening the closing unit 8, the pair of molding inserts 7 is carried with the movable machine plate 10 and/or the carrier plate 41 located thereon, and the pair of molding inserts 7 in the ready position is lowered and is then in a position, in which it is connected to the fixed plate 42 via the holding device 35.

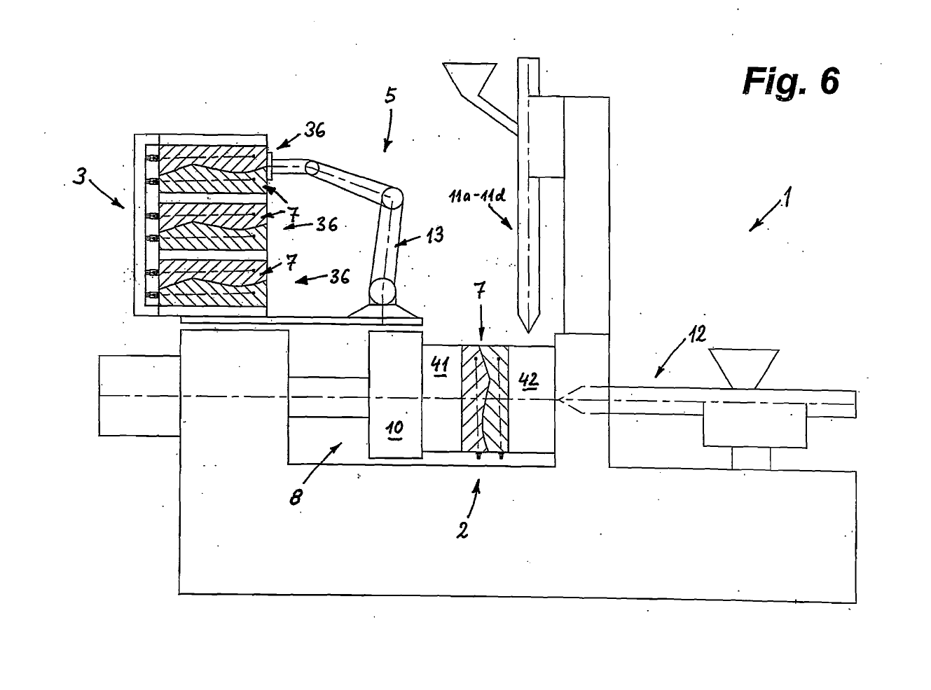

After opening the carrier holder 34 on the movable plate 41, the pair of molding inserts molds 7 can be removed by the bending-arm robot 13 upwards and conveyed to a storage and cooling station 3. (FIG. 6). This placement of a pair of molding inserts 7 filled with injection molded parts may occur in an arbitrary support and cooling station 3 having space available or provided therefore. In FIGS. 4 through 6 it is well discernible that the storage and cooling station 3 is preferably provided with several storage levels 36, so that here several pairs of molding inserts 7 can be stored over top of each other.

In order to shorten the cooling time of the injection molded parts located in the pair of molding inserts 7 active cooling may also be provided. For this purpose, the pair of molding inserts 7 may also be provided with cooling channels 15 as well as connection sites 16 for connectors 17 of cooling mediums arranged at the storage and cooling stations 3. The cooling medium may be liquid or gaseous. By an active cooling, the cooling time is shortened and consequently a lower number of pairs of molding inserts 7 for circulation are sufficient because they are available after a respectively shorter period of time for another injection molding process. The costs of the total arrangement can therefore be reduced.

After the cooling phase, the filled pairs of molding inserts 7 can be conveyed with the help of the bending-arm robot 13 to a molding release station 4, where they are opened and the finished injection molded parts are released and thus expelled.

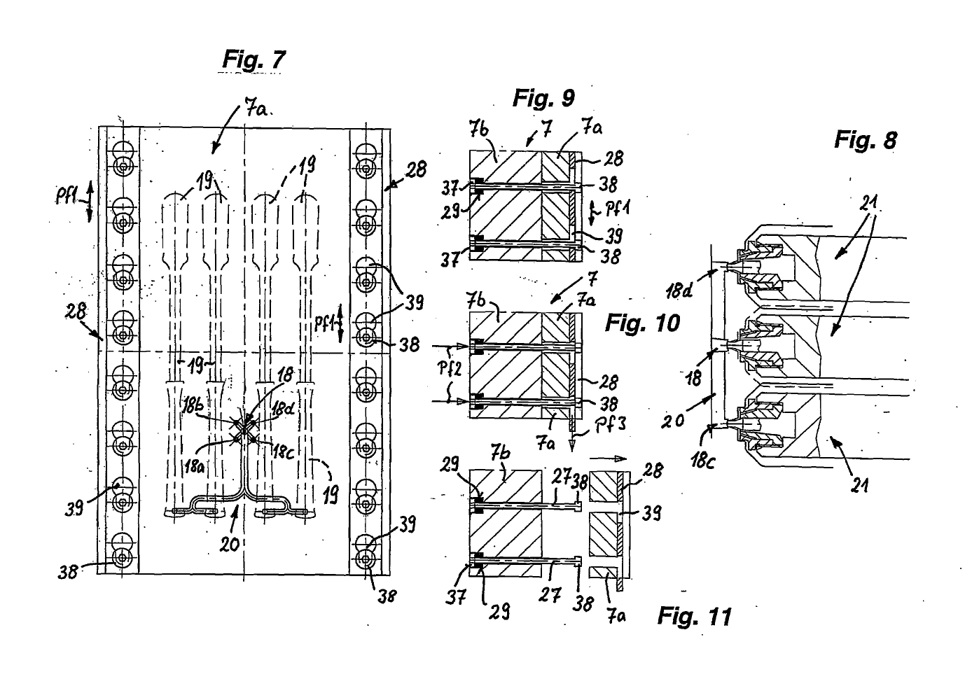

In the exemplary embodiment, the injection molding tool is embodied as a three-plate tool, with the third plate serving as a nozzle-side hot channel distribution plate 42, where the injection aggregates 11a through 11d are also arranged. Between this nozzle-side plate 42 and the nozzle-side half mold 7a there is thus a second separation level. The hot channel distribution system is integrated in the nozzle-side mounting plate. The nozzle-side half mold 7a is provided, according to the arrangement of the needle-valve nozzles 21 (FIG. 8) allocated to the injection aggregates 11a through 11d as well as the injection aggregate 12, with injection points 18, 18a, through 18d, which are well discernible in FIG. 7. These injection points lead to the individual cavities 19 in the nozzle-side half mold 7a via a cold distributor 20. In the exemplary embodiment, in the two half molds 7a, 7b, indicated in dot-dash lines, cavities are provided for four oblong injection molded parts, for example toilet brush bodies. The injection molding tool can thus be embodied both as a single mold for producing one injection part per shot as well as a multiple-cavity mold for four or six injection molding parts, for example. The number of injection aggregates is variable. After the injection molding process, the closed pair of molding inserts 7 is first conveyed to the storage and cooling station 3 and then to the molding release station 4.

In special cases, for example when only comparatively short cooling times are required, the pairs of molding inserts 7 can also be conveyed directly from the injection station 2 to the molding release station 4. Here, the active cooling for the pair of molding inserts 7 may be provided in the area of the molding release station 4, comparable to the one provided in the storage and cooling station 3. If necessary, in this case a cooling phase at a molding release station 4 can be arranged prior to molding release.

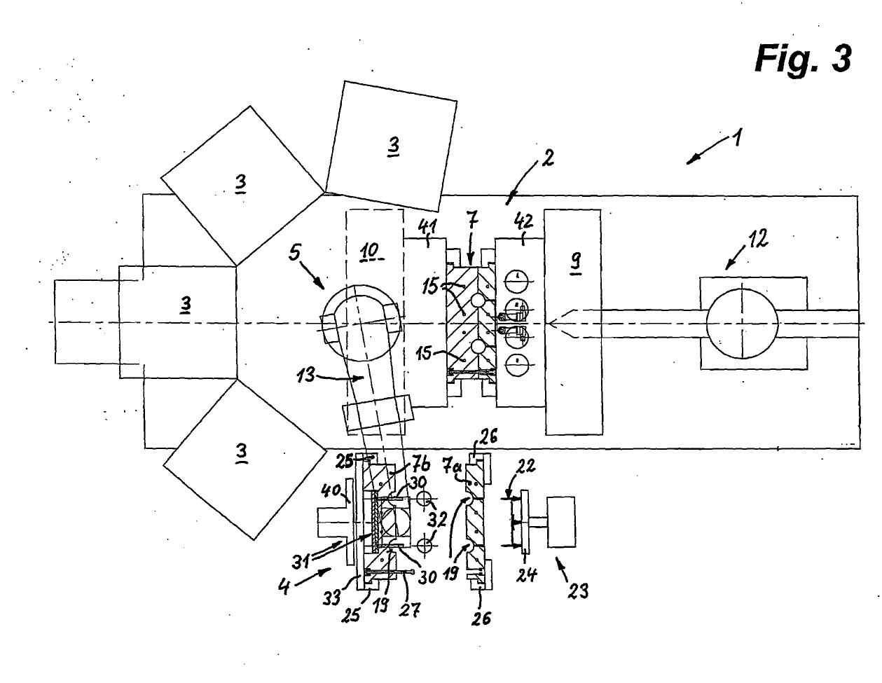

Among other things, a device 23 for removing the sprue 22 is provided at the molding release station 4, having a sprue-picker plate 24 with a grasping element, by which the sprue 22 can be grasped (FIG. 1) and subsequently be torn off, as shown in FIG. 3. The pair of molding inserts 7 is inserted in the molding release station 4 into holding devices 25, 26, which are movable in reference to each other by the lifting elements not shown here, in order to open the half molds 7a, 7b of the pair of molding inserts 7 after unlocking and thus allowing them to move apart. For the lifting motion of the holding devices 25, 26 lifting cylinders, in particular hydraulic cylinders, may be provided.

The opening of the pair of molding inserts 7 occurs therefore after the separation of the sprue 22 and after the locking means 14 for holding the two half molds 7a, 7b together have been opened.

The locking means 14 are provided with holding bolts 27, which penetrate the half molds 7a, 7b. As discernible in FIG. 7 they are provided at both longitudinal sides near the edges, with their number and arrangement depending, among other things, on the closing force required and the geometry of the mold. In FIGS. 1 through 3 the holding bolts 27 are shown only on one side. The holding bolts 27 are inserted into bores from the exterior at the closing-side side of the half molds 7b and contact the exterior bore expansions with their bolt heads 37 on the spring packets 29 (compare FIGS. 9 through 11). The holding bolts 28 are pre-stressed by the spring packets 29 and this pre-stressing determines the holding force of the mold.

The other nozzle-side ends of the holding bolts 27 are also provided with holt heads 38 held at the exterior of the nozzle-side half mold 7a by the locking bars 28.

The bolt heads 38 penetrate the lock openings 39 of the locking bars 28 and by a longitudinal shift of the locking bars 28 according to the double arrows Ff1 in FIGS. 7 and 9, they can be brought into the locking position shown in FIGS. 7 and 9, or into the releasing position shown in FIG. 10, where the heads of the holding bolts 28 are located in the expanded area of the lock hole opening 39, so that the bolt heads 38 can pass through. In this position the pair of molding inserts can be opened, as shown in FIGS. 11 and 3.

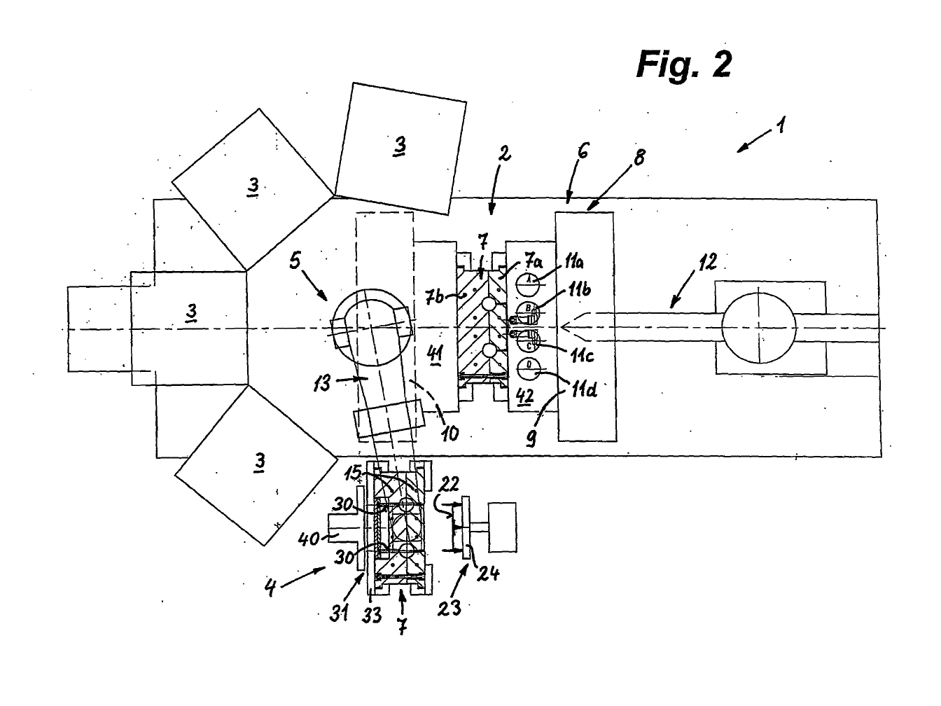

In the opened position of the pair of molding inserts 7, an expulsion unit 31 with an expulsion pin 30 is activated, by which the injection molded parts 32 are expelled. The expulsion unit 31 is partially integrated in the closing-side half mold 7b, which is shown in FIGS. 2 and 3. An exterior operating part 40, located at the molding release station 4, serves as the drive for the expulsion unit 31. In FIG. 2, the expulsion pins 30 are arranged in a retracted position, while in FIG. 3 they are in the expulsion position, with the injection molded parts 32 already being expelled.

In order to release the holding bolt 27 of the pair of molding inserts 7, in the locking position pre-stressed and spring impinged, (FIG. 7, 9), from the pre-stressing for the opening process, the holding bolts 27 is impinged at the back closing-side by the half mold 7b via a pressure pin, not shown, which may be located in the rear plate 33, allocated to the holding device 25 and/or the expulsion unit 31. This pressure impingement of the holding bolt 27 is indicated by the arrows Pf2 in FIG. 10. The locking bars 28 can then be brought, according to the arrow Pf3 in FIG. 10, from the locking position shown in FIGS. 7 and 9 into the releasing position shown in FIG. 10. The locking is then released and the two half molds 7a, 7b can be opened, as shown in FIG. 11.

As already mentioned, the injection molding machine is provided for injecting injection molded parts having foamed cores, with in the exemplary embodiment the injection aggregate 12 serving to inject the core material, while the injection aggregate 11a through 11d serve to inject different enclosures. In particular enclosures can be injection molded in different colors. In the exemplary embodiment four injection aggregates 11a through 11d for the injection molding of four different enclosures are provided. By the structure of the injection tool as a three-plate tool, a mixed, multi-colored production is possible without any problems and a change from one shot to the next and without any color change that would be high in loss. By using needle-valve nozzles, the nozzles allocated to a certain color are separately opened, while the other ones remain closed. Although the connection channels inside the cold distributor 20 (FIG. 7) is filled during the injection with said enclosure material, prior to molding release, the sprue 22 located in the cold distributor 20 is removed at the molding release station 4. This way the complete injection area is free, so that at the next injection shot another color may be injected without any problems. In addition to the possibility to inject different colors per shot there is also the possibility to inject several colors at one shot.

In the storage and cooling stations pairs of molding inserts can be provided for different injection molded parts. Here, a mixed production of different injection molded parts is possible, with the sequence being adjusted to the various injection and cooling periods. For example, during cooling of voluminous injection molded parts, several injection molded parts with shorter cooling periods can be injection molded so that the injection molding machine as a whole can be optimally utilized.

The injection parameters and cooling parameters of the individual different injection molded parts can be stored in a memory device of a control, with this memory also holding the storage position of the molding inserts. The bending-arm robot connected to this control or any handling device of the like can thereby be controlled in an appropriate program process, in which the injection molding station 2 and the molding release station 4 are also integrated.

1. An injection molding machine (1) to injection mold injection molded parts (32) having a core and an enclosure comprising an enclosure material, comprising an injection station (2) and an injection molding tool that can be inserted into a holding device (6), having a pair of molding inserts (7), with the molding inserts including a nozzle-side half mold (7a) and a closing-side half mold (7b), several pairs of the molding inserts (7) are provided, with a locking device being provided to hold each of the pairs of molding inserts (7) together when the holding device (6) is opened and so that the molding inserts can be removed from the holder (6) in a closed position, at least one storage and cooling station (3) and at least one molding release station (4), and a conveyer device (5) is provided for conveying the pair of molding inserts (7) between the injection station (2), the at least one storage and cooling station (3), and the at least one molding release station (4).

2. A machine according to claim 1, wherein the holding device (6) for the injection molding tool is formed by a closing unit (8).

3. A machine according to claim 2, wherein the closing unit (8) is provided with a fixed nozzle-side machine plate (9) and a movable closing-side machine plate (10), on which a closing-side carrier plate (41) is arranged and a nozzle-side hot channel distribution plate (42), between which one of the pairs of molding inserts (7) can be inserted and at the movable machine plate (10) or the carrier plate (41), a carrier holder (34) is provided for the pair of molding inserts (7).

4. A machine according to claim 1, wherein the conveying device comprises a robot-handling device, a bending-arm robot (13) for conveying the pairs of molding inserts (7) between the individual stations (2 through 4).

5. A machine according to claim 1, wherein several of the storage and cooling stations (3) and the at least one molding release station (4) as well as the injection station are arranged in a circular shape around the conveying device (13).

6. A machine according to claim 1, wherein the storage and cooling stations (3) are each provided with several storage levels (36).

7. A machine according to claim 1, wherein the storage and cooling stations (3) include a cooling system for cooling the pairs of molding inserts (7) and the injection molded part or parts located therein.

8. A machine according to claim 7, wherein the pairs of molding inserts (7) are provided with cooling channels (15) for a cooling medium as well as connection sites (16) for cooling medium connectors (18) arranged at the storage and cooling stations (3).

9. A machine according to claim 1 wherein the injection station comprises a co-injection machine and is provided with at least one injection aggregate (11a through 11d) for injecting enclosure material and at least one injection aggregate (12) for injecting core material.

10. A machine according to claim 9, wherein the co-injection machine is provided with several injection aggregates (11a through 11d) for injecting enclosure material.

11. A machine according to claim 1, wherein the injection molding tool comprises a three-plate tool with the nozzle-side machine plate (9) allocated to a nozzle-side half mold (7a), which is particularly provided with feeders embodied as a hot channel distribution system for enclosure material and core material, and injection aggregates (11a through 11d, 12) with needle valve nozzles (21) for injection molding the tools in a cold distributor (20) of the nozzle-side half mold (7a).

12. A machine according to claim 1, wherein the nozzle-side half mold (7a) is provided with several injection sites (18a through 18d) for different types of the enclosure material as well as an injection site (18) for the core material.

13. A machine according to claim 1, wherein the locking device (14) of the pair of molding inserts (7) with the half molds includes holding bolts (27) which penetrate them laterally, which cooperate on a nozzle-side with detachable locking elements, embodied as locking bars (28).

14. A machine according to claim 13, wherein the molding release station (4) is provided with a device for unlocking and locking the locking elements (28) and for opening and closing the pairs of molding inserts (7) as well as a device (23) for removing the injection sprue (22).

15. A machine according to claim 3, wherein the machine plate (10) of the locking unit (8) engaging the closing-side half mold with the movable machine plate (10) or a carrier holder (34) connected to a carrier plate (41) and a holding device (35) engaging the nozzle-side half mold (7a) and connected to the nozzle-side machine plate (9) of the closing unit (8) are each adjustable in a holding and loosening position.

16. A machine according to claim 1, wherein a control for the conveying device (13) is provided a robot handling device, which is provided with a memory for storage positions of the pairs of molding inserts (7) as well as injection parameters and cooling parameters allocated thereto.
